(19) United States
(12) Patent Application Publication
(10) Pub. No.: US 2021/0051246 A1
(43) Pub. Date: Feb. 18, 2021

(54) STRUCTURED LIGHT-EMITTING MODULE

(71) Applicant: TRIPLE WIN TECHNOLOGY(SHENZHEN) CO.LTD., Shenzhen (CN)

(72) Inventors: CHUN-YAO HUANG, New Taipei (TW); CHENG-AN LIN, New Taipei (TW)

(21) Appl. No.: 16/568,919

(22) Filed: Sep. 12, 2019

(30) Foreign Application Priority Data
Aug. 14, 2019 (CN) 201910750977.8

(51) Int. Cl. H04N 5/225; G02B 26/08

(52) U.S. Cl. CPC H04N 5/2253; H04N 5/2252; H04N 5/2254; G02B 26/0833

(57) ABSTRACT

A structured light-emitting module includes a lens housing, a light-emitting element, a lens mounted on the lens housing, and a digital light processing sensor. The light-emitting element is mounted on an inner side wall of the lens housing. The digital light processing sensor is mounted on an inner side wall of the lens housing and is configured to reflect light emitted by the light-emitting element to the lens for transmission.

### FIELD

The subject matter herein generally relates to structured light-emitting modules, and more particularly to a structured light-emitting module having a reduced size.

### BACKGROUND

Generally, a face recognition function of an electronic device uses a structured light-emitting module to emit light. The structured light-emitting module of the related art generally uses a reflective prism structure to transmit light emitted by a light-emitting element to a lens of the light-emitting module. However, due to the reflective prism structure, a size of the structured light-emitting module may be difficult to reduce.

### BRIEF DESCRIPTION OF THE DRAWINGS

Implementations of the present disclosure will now be described, by way of embodiments, with reference to the attached figures.

FIG. 1 is an assembled, isometric view of an embodiment of a structured light-emitting module.

FIG. 2 is an exploded, isometric view of the structured light-emitting module in FIG. 1.

FIG. 3 is a cross-sectional view taken along line in FIG. 1.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

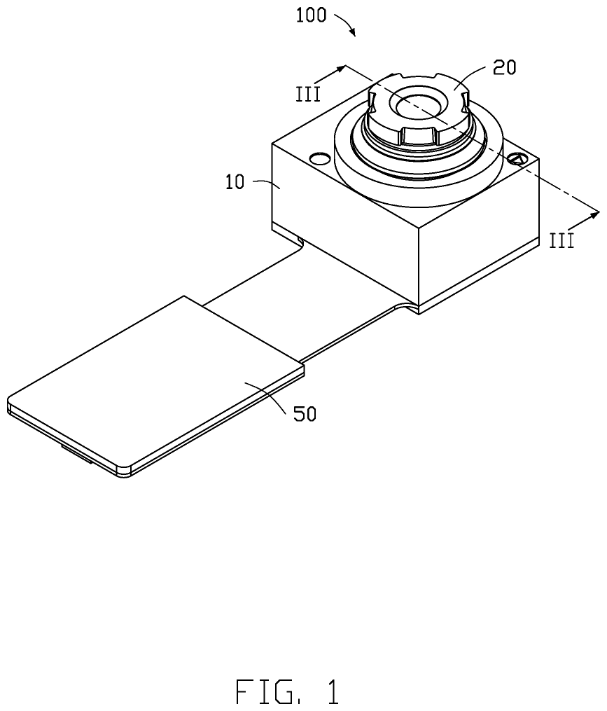

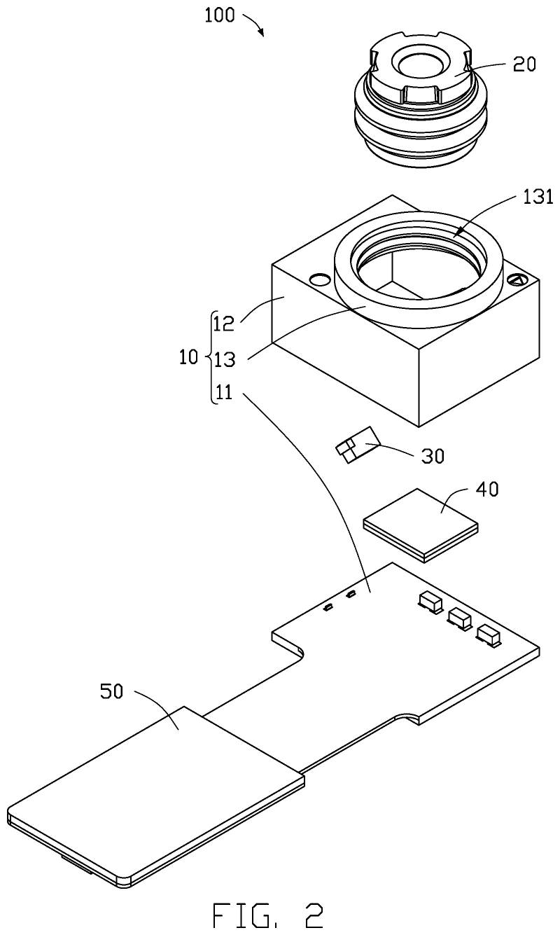

FIGS. 1 and 2 show an embodiment of a structured light-emitting module 100 including a lens housing 10, a lens 20, a light-emitting element 30, and a digital light processing sensor (DLP sensor) 40. The lens 20 is fixed in an opening 131 of the lens housing 10 to form a light transmission opening. The light-emitting element 30 is fixed to an inner side wall of the lens housing 10. The DLP sensor 40 is located on an inner bottom wall of the lens housing 10 for reflecting light emitted by the light-emitting element 30 to the lens 20.

The lens housing 10 includes a bottom portion 11, a main body 12, and a lens portion 13. The lens portion 13 is located on a side of the main body 12 opposite to the bottom portion 11. The main body 12 is substantially a hollow cuboid. In one embodiment, the main body 12 is formed by four rectangular plates connected end-to-end. The main body 12 is located between the bottom portion 11 and the lens portion 13 and surrounds the bottom portion 11 and the lens portion 13 to form a receiving cavity 14. The receiving cavity 14 is configured to receive the light-emitting component 30, the DLP sensor 40, and other components not described herein. The lens portion 13 defines the opening 131, and the opening 131 communicates with the receiving cavity 14. The lens 20 is mounted in the opening 131 of the lens portion 13.

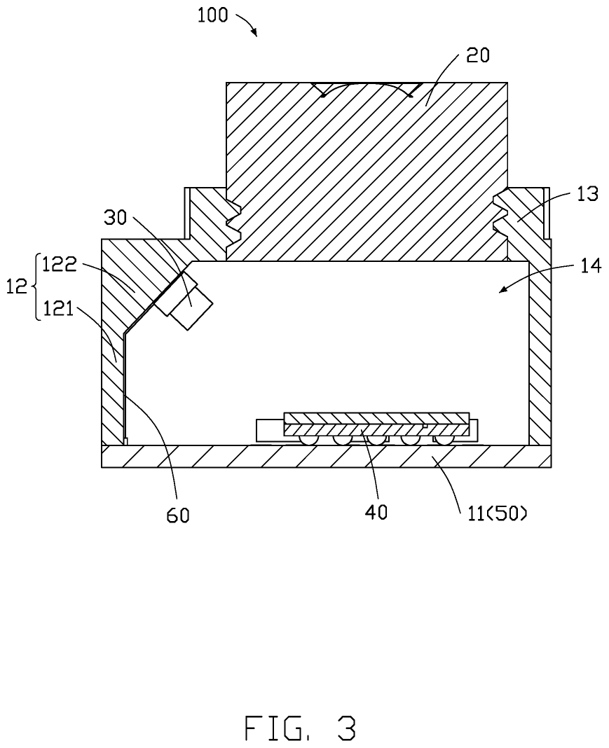

As shown in FIG. 3, the light-emitting element 30 is mounted on an inner side wall of the main body 12. Specifically, the inner side wall of the main body 12 includes a perpendicular portion 121 and a slanted portion 122. The perpendicular portion 121 is connected substantially perpendicularly to the bottom portion 11. The slanted portion 122 is connected to the lens portion 13 and faces the bottom portion 11 at an angle. The light-emitting element 30 is mounted on the slanted portion 122. Specifically, the light-emitting element 30 may be fixed by solder or glue. The light-emitting element 30 may employ a light-emitting diode (LED), a vertical cavity surface emitting laser (VCSEL), or the like.

The structured light-emitting module 100 further includes a control circuit 50. The control circuit 50 is located inside the bottom portion 11. In another embodiment, a circuit board of the control circuit 50 is used as the bottom portion 11 of the lens housing 10. A laser direct structuring (LDS) line 60 is formed on the inner side wall of the main body 12. The light-emitting element 30 is electrically connected to the control circuit 50 via the LDS line 60.

The DLP sensor 40 is mounted on the bottom portion 11 and is electrically coupled to the control circuit 50. The control circuit 50 is configured to control a tilt angle and a deflection time of a digital micro-mirror device (DMD) on the DLP sensor 40 to reflect light having different optical paths emitted by the light-emitting element 30 to the lens 20 to transmit through the lens 20 to an object.

Compared with the related art, the light-emitting element 30 is mounted on the inner side wall of the lens housing 10, and the DLP sensor 40 mounted on the bottom portion 11 changes an outgoing direction of the light emitted by the light-emitting element 30. Thus, a reflective prism in the related art is omitted, and a structure of the structured light-emitting module 100 is further miniaturized.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A structured light-emitting module comprising:
a lens housing;
a light-emitting element;
a lens mounted on the lens housing; and
a digital light processing sensor; wherein:
the light-emitting element is mounted on an inner side wall of the lens housing;
the digital light processing sensor is mounted on an inner side wall of the lens housing and is configured to reflect light emitted by the light-emitting element to the lens for transmission.

2. The structured light-emitting module of claim 1, wherein:
the lens housing comprises a bottom portion, a main body, and a lens portion;
the lens portion is located on a side of the main body opposite the bottom portion;
the main body is located between the bottom portion and the lens portion;
the main body, the bottom portion, and the lens portion cooperatively define a receiving cavity;
the lens is mounted on the lens portion;
the digital light processing sensor is mounted on the bottom portion; and
the light-emitting element is mounted on an inner side wall of the main body.

3. The structured light-emitting module of claim 2, wherein:
the lens portion defines an opening communicating with the receiving cavity; and
the lens is mounted in the opening.

4. The structured light-emitting module of claim 2, wherein:
the lens housing comprises a perpendicular portion and a slanted portion;
the perpendicular portion is coupled to the bottom portion;
the slanted portion is coupled to the lens portion;
the slanted portion faces the bottom portion; and
the light-emitting element is mounted on the slanted portion.

5. The structured light-emitting module of claim 1, wherein:
the light-emitting element is fixed to the inner side wall of the housing by solder or glue.

6. The structured light-emitting module of claim 2, further comprising a control circuit, wherein:
the control circuit is located inside the bottom portion; and
the light-emitting element and the digital light processing sensor are electrically coupled to the control circuit.

7. The structured light-emitting module of claim 6, wherein:
a laser direct structuring line is formed on the inner side wall of the main body; and
the light-emitting element is electrically connected to the control circuit via the laser direct structuring line.

8. A structured light-emitting module comprising:
a lens housing;
a light-emitting element;
a lens mounted on the lens housing; and
a digital light processing sensor; wherein:
the lens housing comprises a bottom portion;
an inner side wall of the lens housing comprises a slanted portion;
the light-emitting element is mounted on the slanted portion of the lens housing and faces the digital light processing sensor at an angle;
the digital light processing sensor is mounted on the bottom portion of the lens housing and is configured to reflect light emitted by the light-emitting element to the lens for transmission.

9. The structured light-emitting module of claim 8, wherein:
the lens housing further comprises a main body and a lens portion;
the lens portion is located on a side of the main body opposite the bottom portion;
the main body is located between the bottom portion and the lens portion;
the main body, the bottom portion, and the lens portion cooperatively define a receiving cavity; and
the lens is mounted on the lens portion;

10. The structured light-emitting module of claim 9, wherein:
the lens portion defines an opening communicating with the receiving cavity; and
the lens is mounted in the opening.

11. The structured light-emitting module of claim 10, wherein:
the light-emitting element is fixed to the inner side wall of the housing by solder or glue.

12. The structured light-emitting module of claim 11, further comprising a control circuit, wherein:
the control circuit is located inside the bottom portion; and
the light-emitting element and the digital light processing sensor are electrically coupled to the control circuit.

13. The structured light-emitting module of claim 12, wherein:
a laser direct structuring line is formed on the inner side wall of the main body; and
the light-emitting element is electrically connected to the control circuit via the laser direct structuring line.
